(19) United States
(12) Patent Application Publication
(10) Pub. No.: US 2015/0205483 A1
(43) Pub. Date: Jul. 23, 2015

(54) OBJECT OPERATION SYSTEM, RECORDING MEDIUM RECORDED WITH OBJECT OPERATION CONTROL PROGRAM, AND OBJECT OPERATION CONTROL METHOD

(71) Applicant: KONICA MINOLTA, INC., Tokyo (JP)

(72) Inventors: Shunsuke TAKAMURA, Tokyo (JP); Shinya OGINO, Tokyo (JP); Kazuma TAKEUCHI, Tokyo (JP); Ikuko TSUBOTANI, Tokyo (JP)

(73) Assignee: KONICA MINOLTA, INC., Tokyo (JP)

(21) Appl. No.: 14/598,976

(22) Filed: Jan. 16, 2015

(30) Foreign Application Priority Data
Jan. 22, 2014 (JP) 2014-009110

(51) Int. Cl. G06F 3/0488; G06F 3/0484; G06F 3/0482; G06F 3/041

(52) U.S. Cl. CPC G06F 3/0488; G06F 3/041; G06F 3/04842; G06F 3/0482; G06F 2203/04104

(57) ABSTRACT

An object operation system includes: a display unit which displays an object on a screen; an operation unit which receives a touch operation on the screen; and a control unit which controls the display unit and the operation unit, wherein when a touch operation for touching a plurality of points on the screen at a time is performed, the control unit determines whether the touch operation is a touch operation performed with both hands or a touch operation performed with a single hand, and carries out an operation on an object in accordance with a rule which is defined differently in advance in accordance with a determination result of the touch operation.

The entire disclosure of Japanese Patent Application No. 2014-9110 filed on Jan. 22, 2014 including description, claims, drawings, and abstract are incorporated herein by reference in its entirety.

### BACKGROUND OF THE INVENTION

1. Field of the Invention

The present invention relates to an object operation system capable of displaying and operating an object, a recording medium storing an object operation control program for controlling operation of an object, and an object operation control method.

2. Description of the Related Art

In recent years, a display screen usable by multiple users (which will be referred to as a shared screen) is used to write and draw display elements (hereinafter referred to as objects) such as characters, figures, and images on the shared screen to have an electronic conference and the like to have a discussion. In such a shared screen, multiple user write various kinds of objects, make multiple objects into a group, move objects and groups to any given place in the shared screen, and perform enlarging/reducing operation (hereinafter referred to as enlarging and reducing operation). In particular, when a shared screen is made of a touch panel supporting multi-touch, various kinds of operations can be done on objects and groups with multi-touch operation.

As a technique of multi-touch operation, for example, JP 2013-8326 A discloses an image processing apparatus including recognition unit configured to recognize touch on two points of the display screen, a selection unit configured to select a type of image processing on the basis of the distance between the two points of the recognized touch, a calculation unit configured to allow a user to touch two points, adopt one of the touched points as a center of rotation, and obtain a rotation angle obtained from movement of the other of the touches, and calculate the amount of processing from the rotation angle, and an image processing unit configured to perform image processing on an image displayed on the display screen on the basis of the amount of processing and the type of the image processing.

JP 2013-37396 A (US 2013-0033717 A) discloses an image forming apparatus including a display unit and a position detection unit configured to detect a contact position onto a display screen of the display unit, wherein the image forming apparatus performs image forming process to form an image on a recording sheet on the basis of a display image displayed on the display unit, and wherein the image forming apparatus includes an editing unit configured to partially edit the display image on the basis of a direction of a straight line connecting two lines detected by the position detection unit.

JP 2012-79279 A (US 2012-0056831 A) discloses an information processing apparatus including a display unit having a screen and a touch panel arranged so as to overlap the screen, wherein the information processing apparatus further includes a control unit sets a writing mode by detecting a predetermined mode switching operation including an operation in which at least two points on the touch panel are designated as a still point and an operation point, and inputting, as writing data, a series of coordinate data corresponding to a trace of movement of the operation points.

In the conventional techniques of JP 2013-8326 A, JP 2013-37396 A (US 2013-0033717 A), and JP 2012-79279 A (US 2012-0056831 A), the difference in the touch operation is recognized, and the operation on the object is changed in accordance with the difference in the touch operation, but in the multi-touch operation, there may be a case where the operation executed on the object may be changed in accordance with two operations in which user's operations performed with an apparatus are completely the same. For example, when a predetermined object and a group including the predetermined object are displayed, the user may touch the predetermined object and the group at a single point of each of them and move the touch position of each of them, thus choosing to use any one of two types of operations including an operation for enlarging or reducing the entire group including the predetermined object and an operation for retrieving the predetermined object from the group and individually moving the predetermined object.

However, in the conventional system as shown in each of JP 2013-8326 A, JP 2013-37396 A (US 2013-0033717 A), and JP 2012-79279 A (US 2012-0056831 A), both of such operations are falsely recognized as completely the same touch operation, and therefore, it is impossible to switch the operation performed on the objects and the groups. For this reason, it is necessary to use a method different from the touch operation to switch the operation on the objects and the groups, and there is a problem in that this makes the operation cumbersome.

### SUMMARY OF THE INVENTION

The present invention has been made in view of the above problem, and it is a main object of the present invention to provide an object operation system, an object operation control program, and an object operation control method capable of switching operation on an object and a group in accordance with touch operation even when the same touch operation is performed.

To achieve the abovementioned object, according to an aspect, an object operation system reflecting one aspect of the present invention comprises a display unit which displays an object on a screen, an operation unit which receives a touch operation on the screen, and a control unit which controls the display unit and the operation unit, wherein when a touch operation for touching a plurality of points on the screen at a time is performed, the control unit determines whether the touch operation is a touch operation performed with both hands or a touch operation performed with a single hand, and carries out an operation on an object in accordance with a rule which is defined differently in advance in accordance with a determination result of the touch operation.

To achieve the abovementioned object, according to an aspect, a non-transitory recording medium storing a computer readable object operation control program operating on an apparatus for controlling a touch panel, including a display unit which displays an object on a screen and an operation unit which receives a touch operation on the screen, wherein the object operation control program reflecting one aspect of the present invention causes the apparatus to execute first processing for, when a touch operation for touching a plurality of points on the screen at a time is performed, determining whether the touch operation is a touch operation performed with both hands or a touch operation performed with a single hand, and second processing for carrying out an operation on an object in accordance with a rule which is defined differently in advance in accordance with a determination result of the touch operation.

To achieve the abovementioned object, according to an aspect, an object operation control method, reflecting one aspect of the present invention, for a system including a display unit which displays an object on a screen, an operation unit which receives a touch operation on the screen, and a control unit which controls the display unit and the operation unit, wherein the control unit executes first processing for, when a touch operation for touching a plurality of points on the screen at a time is performed, determining whether the touch operation is a touch operation performed with both hands or a touch operation performed with a single hand, and second processing for carrying out an operation on an object in accordance with a rule which is defined differently in advance in accordance with a determination result of the touch operation.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic figure illustrating an external configuration of an object operation system according to an embodiment of the present invention;

FIG. 2 is a schematic figure illustrating another external configuration of an object operation system according to an embodiment of the present invention;

FIGS. 3A and 3B are block diagrams illustrating a configuration of an object operation system according to an embodiment of the present invention;

FIG. 4 is a schematic diagram illustrating an example of a detection unit of an object operation system according to an embodiment of the present invention;

FIG. 5 is a schematic diagram illustrating another example of a detection unit of an object operation system according to an embodiment of the present invention;

FIG. 6 is a flowchart diagram illustrating basic processing of an object operation system according to an embodiment of the present invention;

FIG. 7 is a flowchart diagram illustrating processing of the object operation system according to a first embodiment of the present invention (change of operation target);

FIG. 8 is a flowchart diagram illustrating processing of the object operation system according to the first embodiment of the present invention (change of operation target and operation content);

FIG. 9 is a schematic diagram illustrating an example of single touch operation according to the first embodiment of the present invention;

FIGS. 10A and 10B are schematic diagrams illustrating examples of multi-touch operation according to the first embodiment of the present invention;

FIGS. 11A and 11B are schematic diagrams illustrating another example of multi-touch operation according to the first embodiment of the present invention;

FIGS. 12A and 12B are schematic diagrams illustrating another example of multi-touch operation according to the first embodiment of the present invention;

FIG. 13 is a flowchart diagram illustrating an example of processing of an object operation system according to a second embodiment of the present invention;

FIGS. 14A and 14B are schematic diagrams illustrating examples of multi-touch operation according to the second embodiment of the present invention;

FIGS. 15A and 15B are schematic diagrams illustrating another example of multi-touch operation according to the second embodiment of the present invention;

FIGS. 16A and 16B are schematic diagrams illustrating another example of multi-touch operation according to the second embodiment of the present invention;

FIG. 17 is a flowchart diagram illustrating an example of processing of an object operation system according to a third embodiment of the present invention;

FIGS. 18A and 18B are schematic diagrams illustrating examples of multi-touch operation according to the third embodiment of the present invention;

FIGS. 19A and 19B are schematic diagrams illustrating another example of multi-touch operation according to the third embodiment of the present invention;

FIGS. 20A and 20B are schematic diagrams illustrating another example of multi-touch operation according to the third embodiment of the present invention;

FIGS. 21A and 21B are schematic diagrams illustrating another example of multi-touch operation according to the third embodiment of the present invention; and

FIGS. 22A and 22B are schematic diagrams illustrating another example of multi-touch operation according to the third embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples.

When a discussion is held while operating objects such as characters, figures, and images, and groups displayed on a shared screen as explained in the Description of the Related Art, various kinds of operations are performed on the objects and the groups, e.g., moving the objects and the groups or performing enlarging and reducing operation on the objects and the groups. In particular, when a shared screen is made of a touch panel supporting multi-touch, various kinds of operations can be done on objects and groups with multi-touch operation.

In this case, even an operation is recognized as completely the same touch operation, a user may want to execute different operations on the objects and the groups. For example, when pinch operation is performed on a single object in a group (operation for touching two points and changing the distance between the two points), a user may want to either enlarge/reduce the entire group or enlarge/reduce only a target object. Therefore, in a conventional system, as long as an operation is recognized as the same touch operation, operation can be performed only in one of the rules. For this reason, a method different from the touch operation is used to switch the operation, and there is a problem in that the operation is cumbersome.

Therefore, in an embodiment of the present invention, a touch panel is provided with a detection unit for detecting the state of the touch operation (a hand with which the touch operation is performed), and when the multi-touch operation is performed, a determination is made, on the basis of the detection result of the detection unit, as to whether the operation is a multi-touch operation using two fingers of two hands (referred to as a both-hands multi-touch operation) or a multi-touch operation using two fingers of a single hand (referred to as a single-hand multi-touch operation), and when the operation is determined to be the both-hands multi-touch operation, an operation is performed on an element or a group according to a first rule defined in advance, and when the operation is determined to be the single-hand multi-touch operation, an operation is performed on an element or a group according to a second rule different from the first rule. Hereinafter this will be explained with reference to drawings.

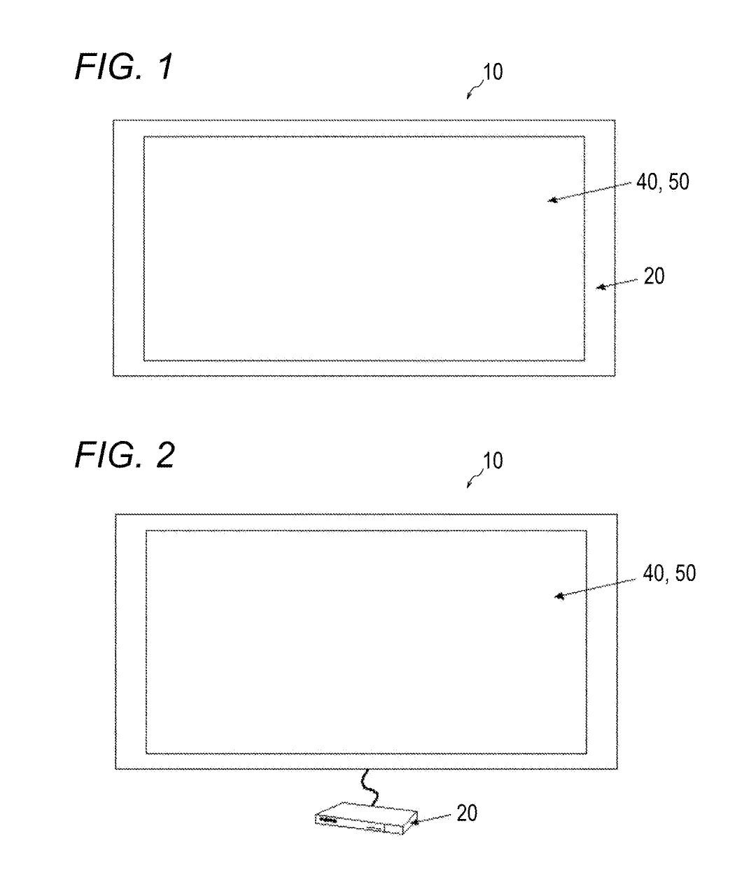

The present invention can be applied to both of the case where there is a single operator and the case where there are multiple operators, but in the present specification, a system having a shared work area that can be operated by multiple operators will be hereinafter explained. The system mode includes the following two modes. As shown in FIG. 1, a first mode is a mode constituted by an apparatus integrally provided with a touch panel having a display unit 40 displaying an object and an operation unit 50 receiving a touch operation, a detection unit 60 for detecting the state of the touch operation (for example, capturing an image of a hand with which a touch operation is performed), and a control unit 20 for controlling them. As shown in FIG. 2, a second mode is a mode in which a touch panel having a display unit 40 and an operation unit 50, a detection unit 60, and a control unit 20 for controlling them are separately provided, and they are connected via a wire or connected wirelessly. Hereinafter, the embodiment will be explained on the basis of the first mode in FIG. 1 for the sake of simplifying the explanation.

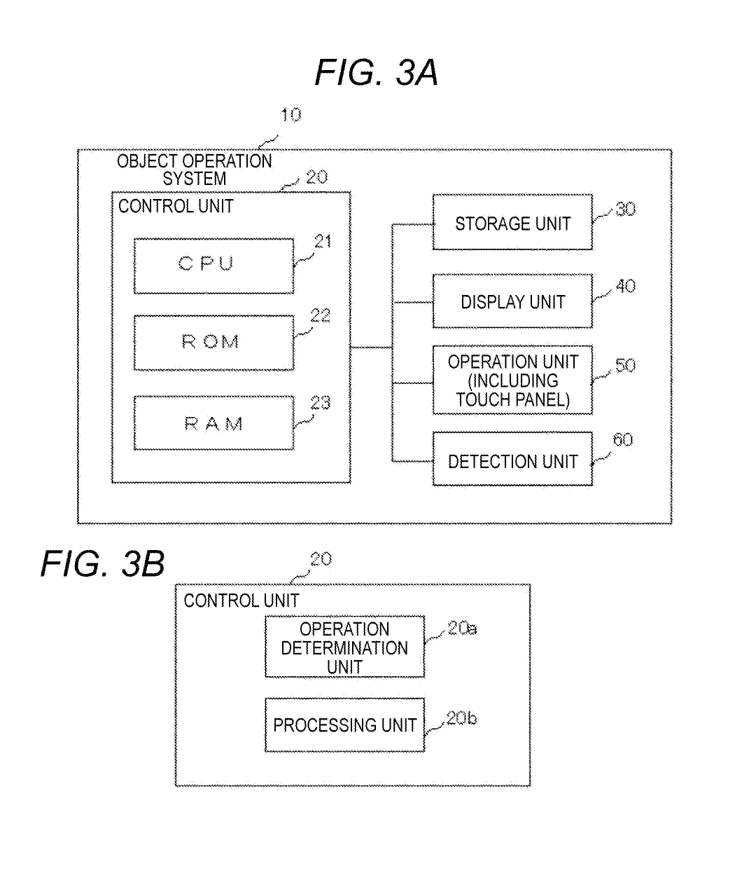

An object operation system 10 according to the present embodiment is a display panel having a calculation function, an electronic blackboard, and the like, and includes a control unit 20, a storage unit 30, a display unit 40, an operation unit 50, a detection unit 60, and the like as shown in FIG. 3A.

The control unit 20 includes a CPU (Central Processing Unit) 21, memories such as a ROM (Read Only Memory) 22, and a RAM (Random Access Memory) 23. The CPU 21 calls a control program from the ROM 22 and the storage unit 30, and extracts the control program to the RAM 23 and executes the control program, thus controlling operation of the entire object operation system 10. As shown in FIG. 3B, the control unit 20 also functions as an operation determination unit 20a and a processing unit 20b.

The operation determination unit 20a determines whether an operation is a touch operation with a touch at a single point (single touch operation) or a touch operation with a touch at multiple points (multi-touch operation) on the basis of information given by the operation unit 50 (information about touch positions). Then, when the operation is determined to be the multi-touch operation, the information given by the detection unit 60 is analyzed, and a determination is made as to whether the multi-touch operation is the both-hands multi-touch operation or the single-hand multi-touch operation on the basis of the analysis result. Then, the determination result (touch positions and the type of the touch operation) is notified to the processing unit 20b.

It should be noted that the method for determining the multi-touch operation is not particularly limited, but for example, an image is obtained when the display screen is touched with multiple fingers of a single hand or both of the hands, and a pattern obtained by extracting feature points of each of the images is stored, and a determination is made as to whether the operation is the both-hands multi-touch operation or the single-hand multi-touch operation by comparing the image of the hands obtained from the detection unit 60 with the images stored in advance.

A touch area size and a touch pressure of each of the touch positions are obtained when the touch panel is touched with multiple fingers of a single hand or both of the hands, and a combination pattern of the touch area size and the touch pressure is stored, and a determination is made as to whether the operation is the both-hands multi-touch operation and the single-hand multi-touch operation by comparing the touch area size and the touch pressure obtained by the operation unit 50 with the combination pattern stored in advance. For example, when the touch panel is touched with both hands, the same fingers are used in many cases, and when the same fingers of both of the hands are used, the touch area size and the touch pressure are substantially the same. On the other hand, when the touch panel is touched with different fingers of a single hand, the touch area size and the touch pressure are different, and therefore, whether the operation is the both-hands multi-touch operation or the single-hand multi-touch operation can be determined on the basis of the combination of the touch area size and the touch pressure. In this case, the state of the touch operation can be determined on the basis of information given by the operation unit 50, and therefore, the detection unit 60 may be omitted.

In accordance with operation with the operation unit 50, the processing unit 20b displays a hand-written object on the display unit 40, obtains data of an object from the storage unit 30, and displays the object on the display unit 40. The processing unit 20b selects an object (element) or a group which is to be operated, on the basis of the determination result given by the operation determination unit 20a (the touch position and the type of the touch operation), and performs operation on the selected object or group and changes the state of display of the object or the group. For example, when the operation determination unit 20a determines that the operation is the single touch operation, an object displayed at the touch position on the screen of the display unit 40 (hereinafter abbreviated as a touched object) or a group including the touched object is moved in accordance with the change of the touch position. When the operation determination unit 20a determines that the operation is the both-hands multi-touch operation, the touched object or the group including the touched object is changed in accordance with the first rule associated in advance with the both-hands multi-touch operation (for example, the object is enlarged, reduced, or moved in accordance with the change of the two touch positions). When the operation determination unit 20a determines that the operation is the single-hand multi-touch operation, the touched object or the group including the touched object is changed in accordance with the second rule associated in advance with the single-hand multi-touch operation (for example, the group is enlarged or reduced in accordance with the change of the two touch positions).

It should be noted that the enlarging and reducing operation according to the present invention includes both of enlargement and reduction of the size while maintaining a certain ratio between the vertical side and the horizontal side of an object (which means similar figure) and enlargement or reduction of the size while changing the ratio between the vertical side and the horizontal side of an object (which means deformation).

A group according to the present invention is considered to be constituted by a single or multiple objects registered in advance, but multiple objects in a predetermined range (for example, objects in a predetermined range from the center, i.e., the touched object) may be adopted as the group. A group may be constituted based on the types of objects, or a group may be constituted based on the sizes and the colors of objects. When data of objects are managed in a hierarchical structure, one or multiple objects in the same level of hierarchy may be adopted as the group. When objects are associated with users, one or multiple objects associated with the same user may be adopted as a group. An area of a group according to the present invention may be only a display area of objects, or may be an area including the vicinity of objects.

The operation determination unit 20a and the processing unit 20b may be made as hardware, or may be executed by causing the CPU 21 provided in the control unit 20 to execute software functioning as the operation determination unit 20a and the processing unit 20b (operation control program).

The storage unit 30 is constituted by a memory, an HDD (Hard Disk Drive), an SSD (Solid State Drive), and the like, and stores the contents of operation performed with the operation unit 50 (information about the touch position, the type of the touch operation, and the like), information about an object displayed on the display unit 40 (information about data of objects, a number for identifying an object, objects constituting a group, and the like), a pattern for determining whether the touch operation is the both-hands multi-touch operation or the single-hand multi-touch operation, and the like. When the functions of the operation determination unit 20a and processing unit 20b are achieved by causing the CPU 21 to execute the display control program, then this display control program is stored to the storage unit 30.

The display unit 40 is constituted by an LCD (Liquid Crystal Display), an organic EL (Electro Luminescence) display, and the like, and provides a shared work area in which multiple operators can operate objects. The operation unit 50 is constituted by a touch sensor made of lattice-like electrodes arranged on the display unit 40, hard keys, and the like, and is configured to receive operations performed by the user. The display unit 40 and the operation unit 50 constitute a touch panel, and a signal according to touch operation performed on the touch panel is output to the operation determination unit 20a and the processing unit 20b.

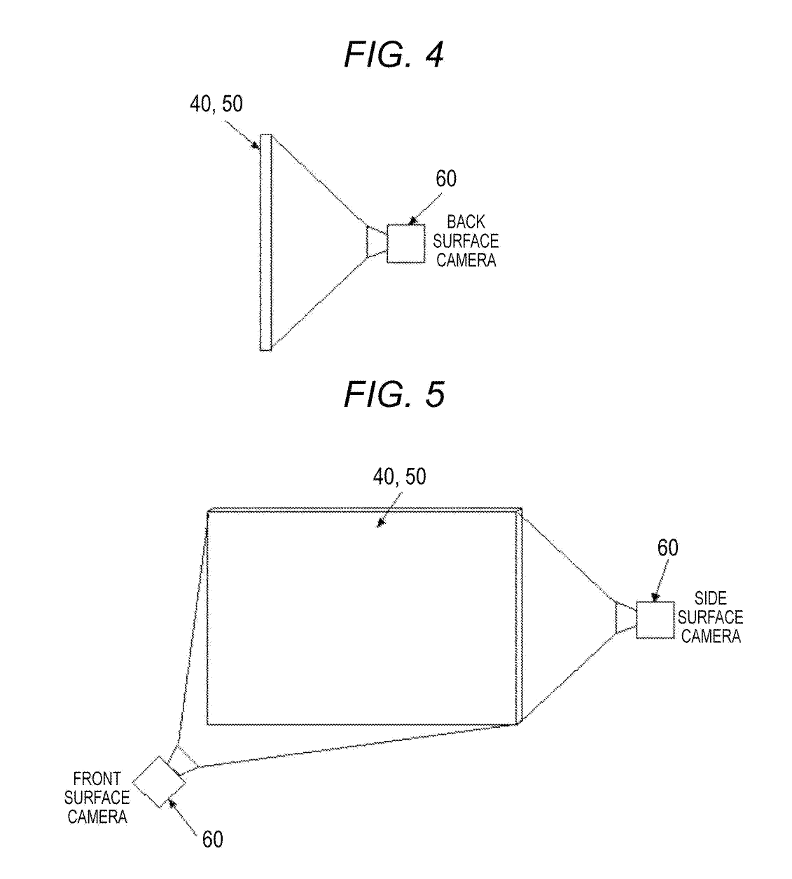

The detection unit 60 is constituted by a CCD (Charge Coupled Devices) camera and the like, and uses visible light or infrared light to capture an image of a hand with which a touch operation is performed, and outputs captured image data or data obtained by processing image data (for example, data obtained by extracting the contour of an image and the like) to the operation determination unit 20a. As long as this detection unit 60 is capable of capturing an image of a hand with which a touch operation is performed, the configuration and the arrangement thereof are not particularly limited. For example, when the touch panel has optical transparency, the detection unit 60 is arranged on the back surface side of the touch panel as shown in FIG. 4. An image of a hand with which a touch operation is performed is captured from the back surface side of the touch panel. Such systems include PixelSense (registered trademark) of Microsoft (registered trademark) Corporation, MultiTaction (registered trademark) of MultiTouch, and the like. When a touch panel does not have optical transparency or when an existing touch panel is used, the detection unit 60 is disposed at the front surface or the side surface of the touch panel as shown in FIG. 5, and captures an image of a hand with which a touch operation is performed from the front surface side of the touch panel. In the present embodiment, the detection unit 60 is provided separately from the touch panel. Alternatively, the detection unit 60 may be configured to be integrated with the touch panel.

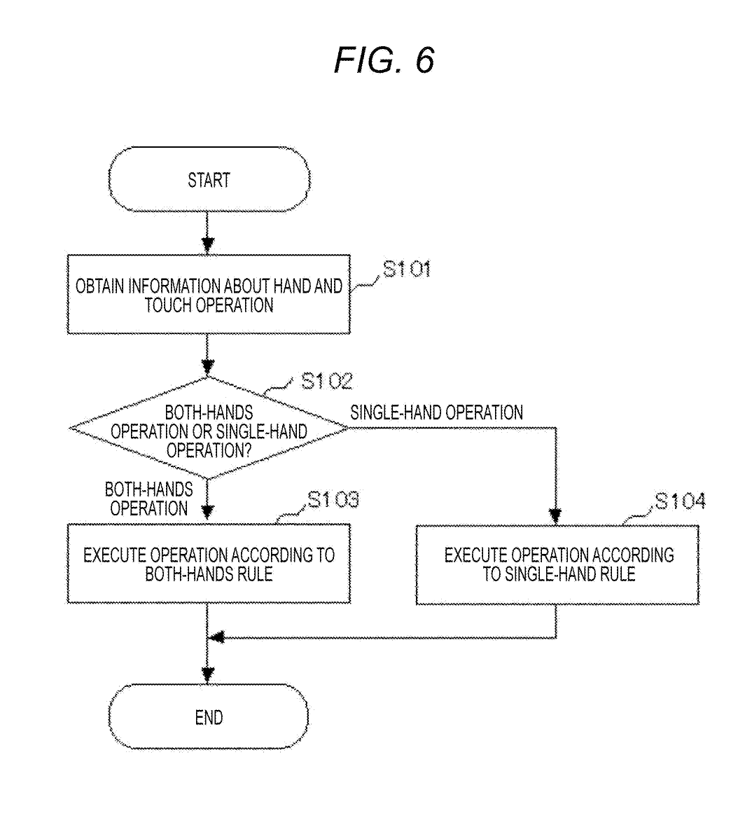

Hereinafter, an operation control method of an object using the object operation system 10 having the above configuration will be explained. The CPU 21 extracts an operation control program stored in the ROM 22 or the storage unit 30 to the RAM 23 and executes the operation control program, thus executing processing in each step as shown in the flowchart diagram of FIG. 6. In the following flow, multiple objects are displayed on the display unit 40 (touch panel) in advance, and a user can operate an object on the touch panel using two fingers.

First, the operation determination unit 20a obtains information about the touch operation from the operation unit 50 (information about the touch position), and obtains information about a hand with which a touch operation is performed from the detection unit 60 (image data of a hand or contour data of a hand) (S101).

Subsequently, the operation determination unit 20a compares information about a hand with which a touch operation is performed and a pattern stored in the storage unit 30 in advance, thus determining whether a touch operation is a both-hands multi-touch operation (the touch positions are associated with different hands) or a single-hand multi-touch operation (the touch positions are associated with the same hand) (S102).

Then, when the touch operation is determined to be the both-hands multi-touch operation, the processing unit 20b performs operation on an object or a group in accordance with the first rule associated with the both-hands multi-touch operation in advance (S103). On the other hand, when the touch operation is determined to be the single-hand multi-touch operation, the processing unit 20b executes operation on the object or the group in accordance with the second rule associated with the single-hand multi-touch operation in advance (S104).

As described above, even if information about the touch operation detected by the touch panel is completely the same, different operations can be carried out by determining whether a touch operation is performed with a single hand or both hands. Therefore, when a target having a hierarchical structure is operated, an operation target can be selected with a single multi-touch operation. For example, whether an object is operated or a group is operated can be selected by a single multi-touch operation. An operation content can be selected by a single multi-touch operation. For example, whether an object or a group is moved or is enlarged/reduced can be selected by a single multi-touch operation. Therefore, the object and the group can be operated efficiently, which can improve the user's convenience.

Even when a user operates an object having a multi-layer hierarchical structure, e.g., another group (large group) is formed by collecting multiple groups (small groups), an operation target (small group/large group) and an operation content (movement/enlarging and the like) can be selected by a single multi-touch operation. Even when a window is displayed on a screen and a sub-window is displayed in the window, the sub-window is adopted as an object and the window is adopted as a group, so that an operation target (object/group) and an operation content (movement/enlarging and the like) can be selected by a single multi-touch operation.

### First Embodiment

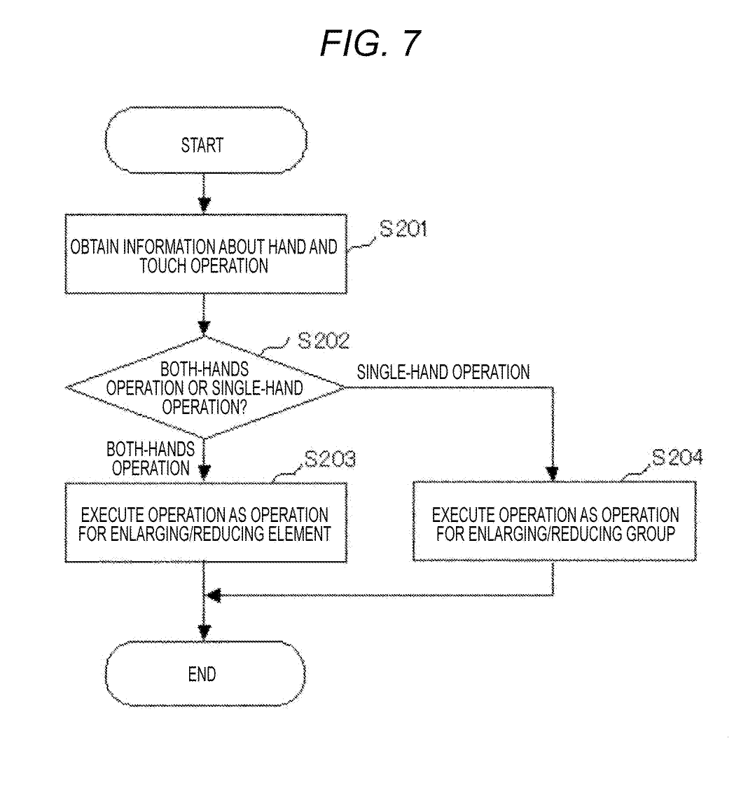

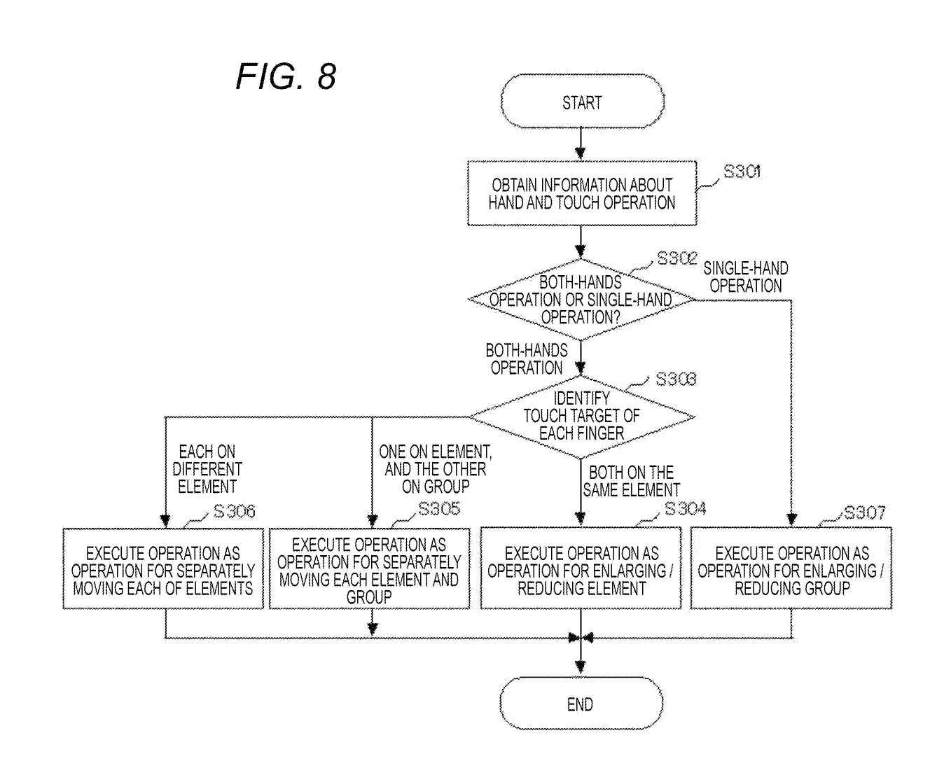

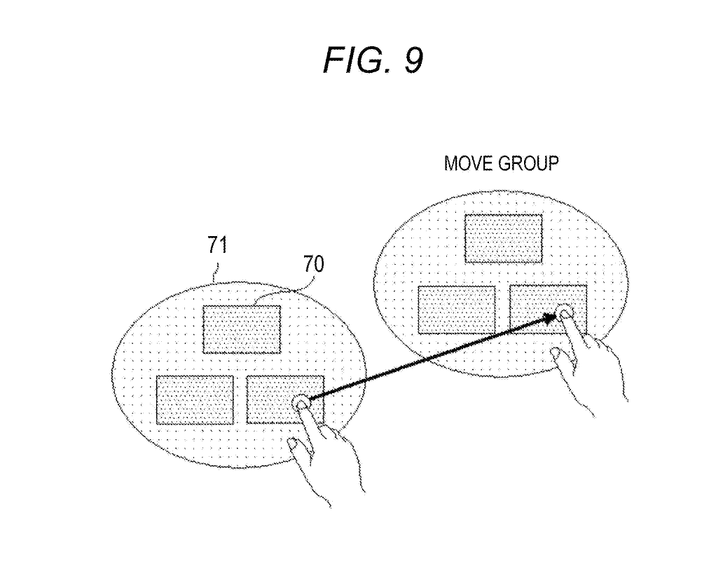

In order to explain the embodiments of the present invention described above further in details, the object operation system, the object operation control program, and the object operation control method according to the first embodiment of the present invention will be explained with reference to FIG. 7 to FIG. 12B. FIGS. 7 and 8 are flowchart diagrams illustrating processing of an object operation system according to the present embodiment. FIGS. 9 to 12B are schematic diagrams illustrating specific examples of touch operations. The configuration of the object operation system 10 is the same as what has been described in the above embodiment, and therefore explanation thereabout is omitted. In the present embodiment, both-hands multi-touch operation is an operation performed on an object, and single-hand multi-touch operation is an operation performed on a group.

An operation control method of an object according to the present embodiment will be explained. The CPU 21 extracts an operation control program stored in the ROM 22 or the storage unit 30 to the RAM 23 and executes the operation control program, thus executing processing in each step as shown in the flowchart diagrams of FIGS. 7 and 8. In the following flow, multiple objects are displayed on the display unit 40 (touch panel) in advance, and any multiple objects are registered as a group in advance, and a user operates an object on the touch panel using two fingers.

First, processing for changing an operation target will be explained with reference to FIG. 7. The operation determination unit 20a obtains information about the touch operation from the operation unit 50, and obtains information about a hand with which a touch operation is performed from the detection unit 60 (S201). Then, the operation determination unit 20a compares information about a hand with which a touch operation is performed with a pattern stored in the storage unit 30, thus determining whether the touch operation is the both-hands multi-touch operation or the single-hand multi-touch operation (S202).

When the touch operation is determined to be the both-hands multi-touch operation, the processing unit 20b executes operation for enlarging and reducing the element (object) (S203). On the other hand, when the touch operation is determined to be the single-hand multi-touch operation, the processing unit 20b executes operation for enlarging and reducing the group (S204). More specifically, the operation target (element/group) is switched according to whether the touch operation is the both-hands multi-touch operation or the single-hand multi-touch operation.

Subsequently, processing for changing the operation target and the operation content will be explained with reference to FIG. 8. Like the above case, the operation determination unit 20a obtains information about the touch operation from the operation unit 50, and obtains information about a hand with which a touch operation is performed from the detection unit 60 (S301). Then, the operation determination unit 20a compares information about a hand with which a touch operation is performed and a pattern stored in the storage unit 30 in advance, thus determining the touch operation is the both-hands multi-touch operation or the single-hand multi-touch operation (S302).

When the touch operation is determined to be the both-hands multi-touch operation, the processing unit 20b identifies the target touched by each finger on the basis of the touch position of the finger (S303). More specifically, a determination is made as to whether each finger is touching the same element (the same object), one of the fingers is touching an element (object) and the other of the fingers is touching a group (a portion of the group area other than the objects), or fingers are touching different elements (different objects).

When each finger touches the same element, the processing unit 20b executes operation for enlarging and reducing a touched element (S304). When one of the fingers is touching an element and the other of the fingers is touching a group, the processing unit 20b executes for separately moving the element and the group (S305). When the fingers are touching different elements, the processing unit 20b executes for separately moving each element (S306).

On the other hand, when the touch operation is determined to be the single-hand multi-touch operation in S302, the processing unit 20b executes operation for enlarging and reducing the group (S307). More specifically, the operation target (element/group) is switched according to whether the touch operation is the both-hands multi-touch operation or the single-hand multi-touch operation, and the operation content (movement/enlarging and reducing operation) is switched on the basis of the touch target.

Hereinafter, this will be hereinafter explained in a more specific manner with reference to FIGS. 9 to 12B. It should be noted that FIGS. 9 to 12B are examples of operation control of objects, and the operation target and the operation content can be changed as necessary. In the drawing, the object 70 is represented as a rectangular shape, but the size and the shape of an object are not limited. In order to identify objects constituting a group in the drawings, multiple objects constituting the group is enclosed by a frame, but an area or a frame of a group may not be required to be displayed on a screen, and an area in proximity to objects constituting a group may be adopted as the area of the group. In the drawings, in order to clarify which portion is touched by each finger, a touch position is indicated by a circle, but the touch position is not required to be displayed on a screen.

FIG. 9 illustrates a case where the touch screen is touched with a single finger. When any one of the objects 70 constituting the group 71 is touched with a single finger and the touch position is moved, for example, the entire group 71 (three objects 70 constituting the group 71) is moved to the movement destination of the touch position.

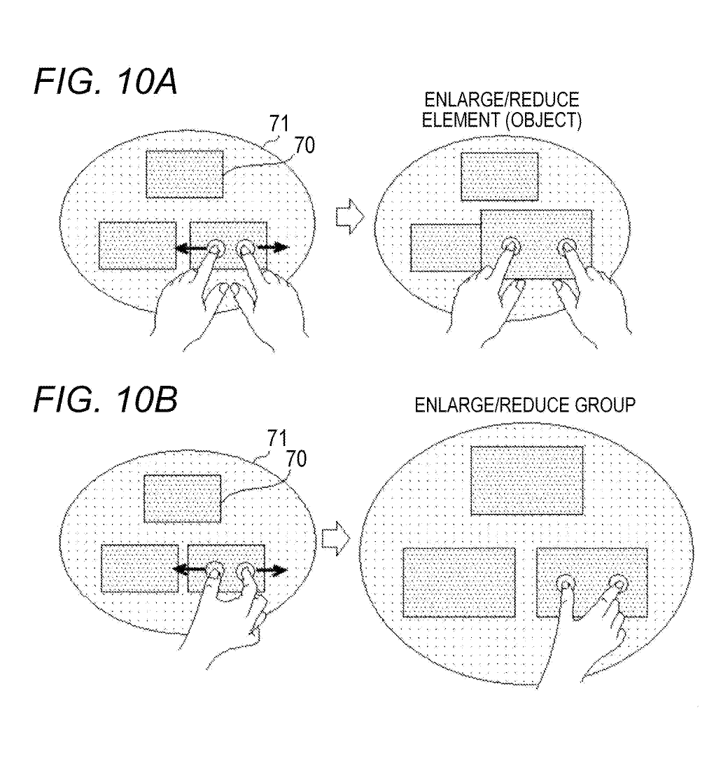

FIGS. 10A and 10B illustrate examples where the operation target is changed in accordance with the touch operation. For example, as shown at the left drawing of FIG. 10A, when any one of the objects 70 constituting the group 71 is touched with two fingers of both hands (the index finger of the right hand and the index finger of the left hand in this case), and so-called pinch operation for changing the distance between the two fingers (pinch out operation for expanding the distance in this case) is performed, then, as shown at the right drawing of FIG. 10A, the element (touched object 70) is adopted as an operation target, and the object 70 is enlarged or reduced (enlarged in this case) in accordance with the change of the distance between the two fingers (processing in S304 of FIG. 8).

On the other hand, as shown at the left drawing of FIG. 10B, when any one of the objects 70 constituting the group 71 is touched with two fingers of a single hand (the thumb of the right hand and the index finger of the right hand in this case), and so-called pinch operation for changing the distance between the two fingers (pinch out operation for expanding the distance in this case) is performed, then, as shown at the right drawing of FIG. 10B, the group 71 (the three objects 70 in this case) is adopted as an operation target, and the entire group 71 is enlarged or reduced (enlarged in this case) in accordance with the change of the distance between the two fingers (processing in S307 of FIG. 8).

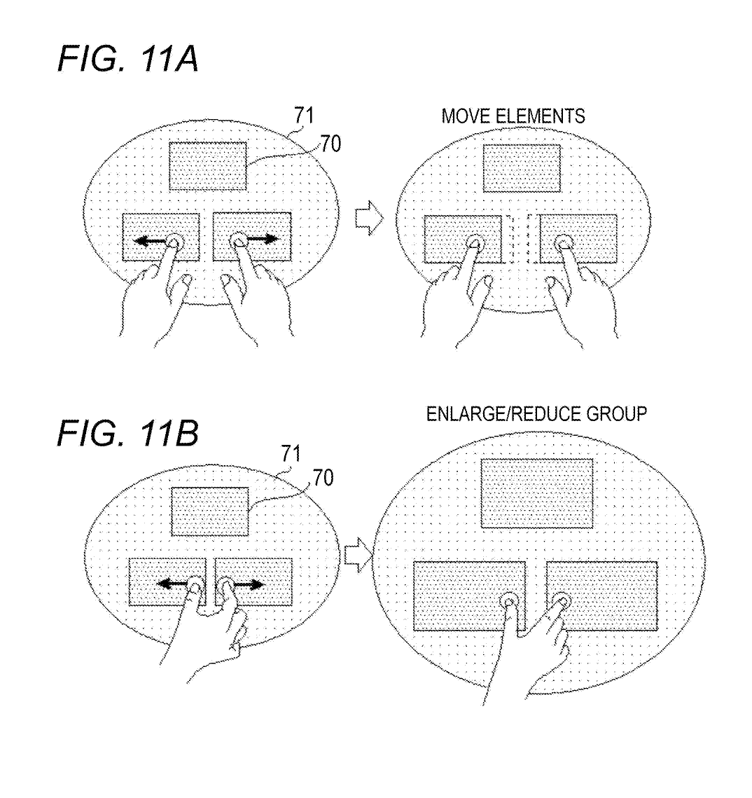

FIGS. 11A and 11B illustrate an example where both of the operation target and the operation content are changed in accordance with the touch operation. For example, as shown at the left drawing of FIG. 11A, when two objects 70 constituting the group 71 are touched with two fingers of both hands, and so-called pinch operation for changing the distance between the two fingers (pinch out operation for expanding the distance in this case) is performed, then, as shown at the right drawing of FIG. 11A, the elements (the two touched objects 70) are adopted as an operation targets, and the two objects 70 are moved in accordance with the change of the distance between the two fingers (processing in S306 of FIG. 8).

On the other hand, as shown at the left drawing of FIG. 11B, when two objects 70 constituting the group 71 are respectively touched with two fingers of a single hand, and so-called pinch operation for changing the distance between the two fingers (pinch out operation in this case) is performed, then, as shown at the right drawing of FIG. 11B, the entire group 71 (the three objects 70) are adopted as an operation targets, and the entire group 71 is enlarged or reduced (enlarged in this case) in accordance with the change of the distance between the two fingers (processing in S307 of FIG. 8).

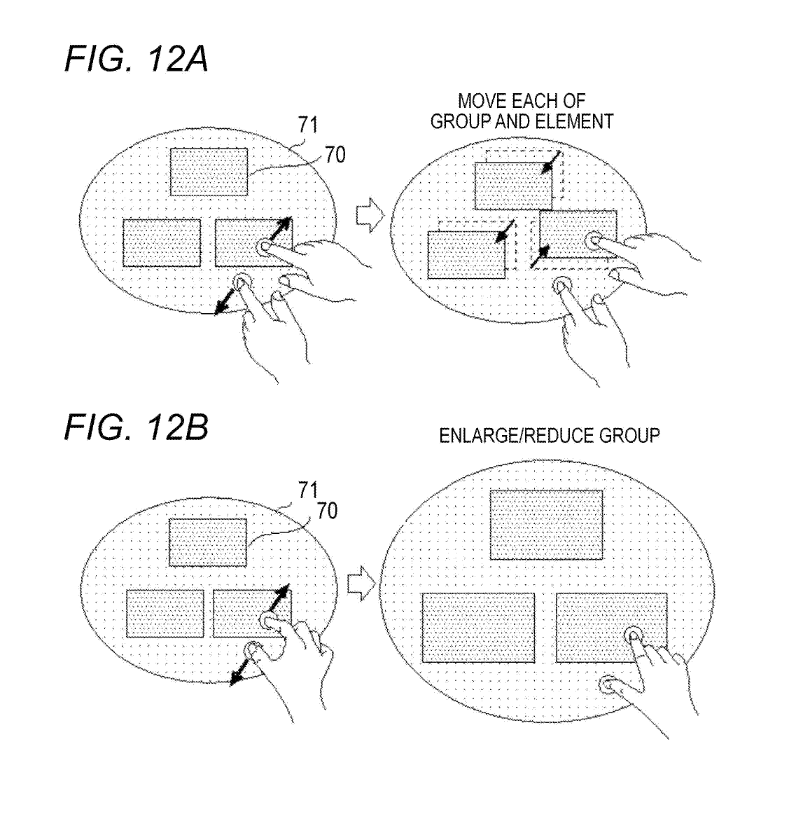

FIGS. 12A and 12B illustrate another example where both of an operation target and an operation content are changed in accordance with the touch operation. For example, as shown at the left drawing of FIG. 12A, when an object 70 constituting a group 71 and an area of a group 71 are respectively touched with two fingers of both hands, and so-called pinch operation for changing the distance between the two fingers (pinch out operation in this case) is performed, then, as shown in the right drawing of FIG. 12A, the element (touched object 70) and the group 71 (the objects 70 other than the touched object 70) are adopted as the operation target, the touched object 70 is moved in the direction of one of the fingers and the group 71 is moved in the direction of the other of the fingers in accordance with the change of the distance between the two fingers (processing in S305 of FIG. 8).

On the other hand, as shown in the left drawing of FIG. 12B, when an object 70 constituting a group 71 and an area of a group 71 are respectively touched with two fingers of a single hand, and so-called pinch operation for changing the distance between the two fingers (pinch out operation in this case) is performed, then, as shown in the right drawing of FIG. 12B, the group 71 (three objects 70 in this case) is adopted as the operation target, the entire group 71 is enlarged or reduced (enlarged in this case) in accordance with the change of the distance between the two fingers (processing in S307 of FIG. 8).

As described above, when the multi-touch operation is performed, the operation target (element/group) is switched in accordance with whether the operation is the both-hands multi-touch operation or the single-hand multi-touch operation, and further, the operation content (movement/enlarging and reducing operation and the like) is switched in accordance with the touched target. Therefore, the object and the group can be operated efficiently, which can improve the user's convenience.

### Second Embodiment

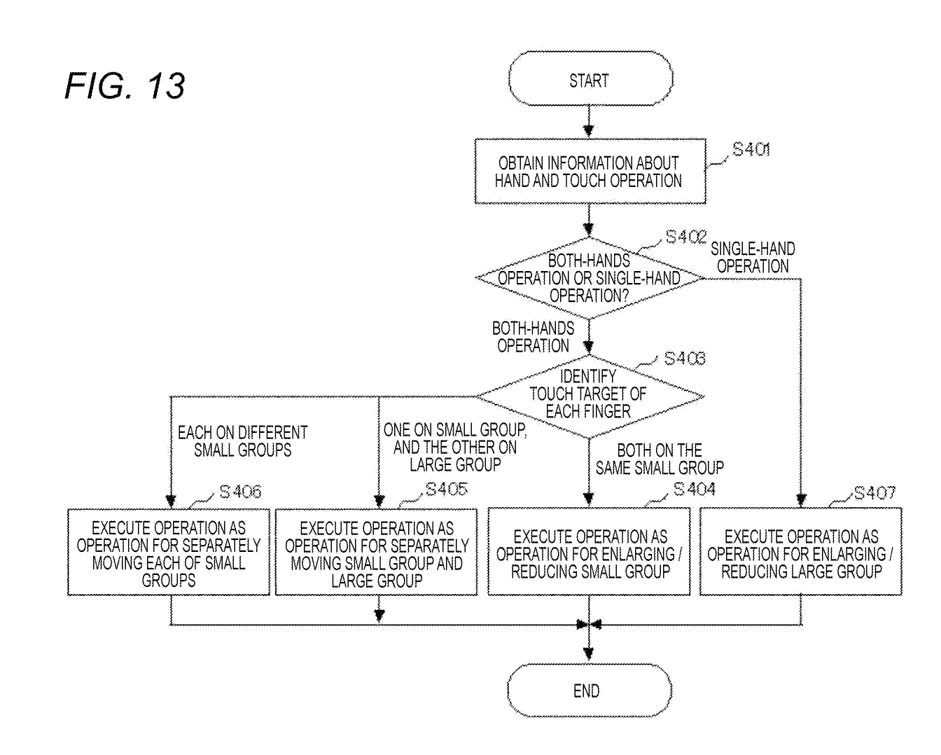

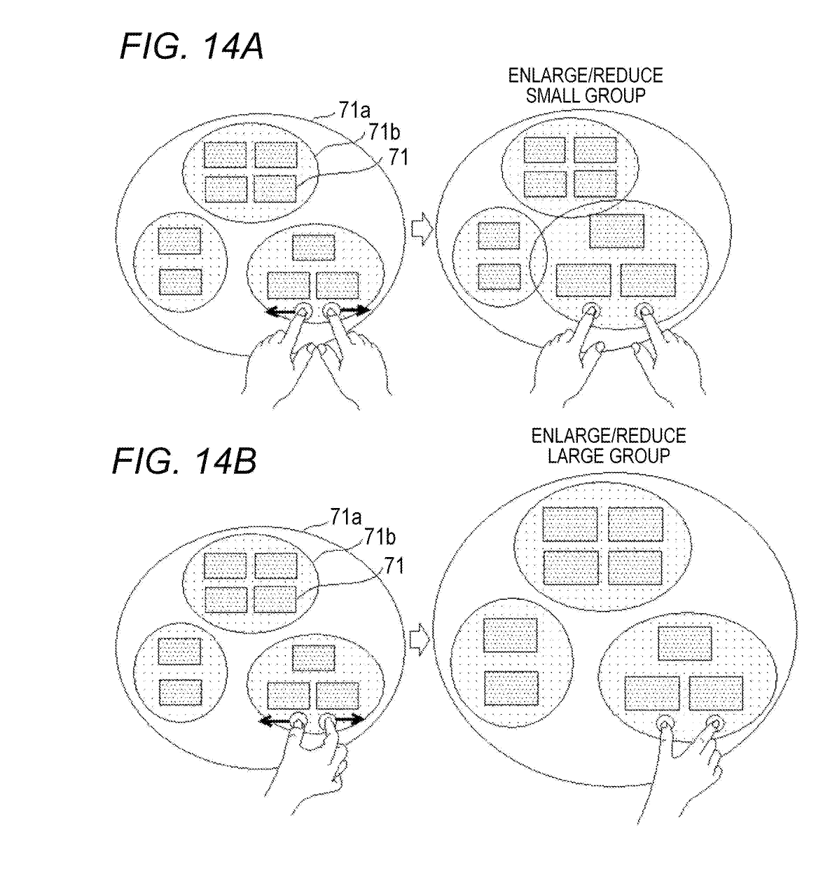

Subsequently, an object operation system, an object operation control program, and an object operation control method according to the second embodiment of the present invention will be explained with reference to FIGS. 13 to 16B. FIG. 13 is a flowchart diagram illustrating processing of an object operation system according to the present embodiment. FIGS. 14A to 16B are schematic diagrams illustrating specific examples of touch operations. The configuration of the object operation system 10 is the same as what has been described in the above embodiment, and therefore explanation thereabout is omitted.

In the first embodiment explained above, the element and the group are switched as the operation target in accordance with the touch operation, but when an object is managed in a multi-layer hierarchical structure, a first group (referred to as a small group) may be formed by one or more objects, and further, a second group (referred to as a large group) may be formed by multiple first groups or the first group and at least another object. Therefore, in the present embodiment, a case where a large group and a small group are switched as an operation target will be explained. It should be noted that the small group of the present embodiment corresponds to the element of the first embodiment, and the large group of the present embodiment corresponds to the group of the first embodiment.

The operation control method of the object in this case will be explained. The CPU 21 extracts an operation control program stored in the ROM 22 or the storage unit 30 to the RAM 23 and executes the operation control program, thus executing processing in each step as shown in the flowchart diagram of FIG. 13. In the following flow, multiple objects are displayed on the display unit 40 (touch panel) in advance, and multiple small groups including multiple objects are registered in advance, and further, one or more large groups including multiple small groups are registered in advance, and a user uses two fingers to generate a small group or a large group on the touch panel.

First, the operation determination unit 20a obtains information about the touch operation from the operation unit 50, and obtains information about a hand with which a touch operation is performed from the detection unit 60 (S401). Then, the operation determination unit 20a compares information about a hand with which a touch operation is performed with a pattern stored in the storage unit 30 in advance, thus determining whether the touch operation is the both-hands multi-touch operation or the single-hand multi-touch operation (S402).

When the touch operation is determined to be the both-hands multi-touch operation, the processing unit 20b identifies the target touched by each finger on the basis of the touch position of the finger (S403). More specifically, a determination is made as to whether each finger is touching the same group, one of the fingers is touching a small group and the other of the fingers is touching a large group (a portion of the area of the large group other than the small group), or each finger is touching different small group.

When each finger is determined to be touching the same small group, the processing unit 20b executes operation for enlarging and reducing the touched small group (S404). When one of the fingers is determined to be touching a small group and the other of the fingers is determined to be touching a large group, the processing unit 20b executes operation for separately moving the small group and the large group (S405). When each finger is determined to be touching different small group, the processing unit 20b executes operation for separately moving each of the small groups (S406).

On the other hand, when the touch operation is determined to be the single-hand multi-touch operation in S402, the processing unit 20b executes operation for enlarging and reducing a large group (S407). More specifically, in accordance with whether the touch operation is the both-hands multi-touch operation or the single-hand multi-touch operation, the operation target (small group/large group) is switched, and on the basis of the touch target, the operation content (movement/enlarging and reducing operation) is switched.

Hereinafter, this will be explained in details with reference to FIGS. 14A to 16B. It should be noted that FIGS. 14A to 16B are examples of operation control of objects, and the operation target and the operation content can be changed as necessary. For example, FIGS. 14A to 16B illustrate a case where a large group is formed by multiple small groups. However, the same control can also be applied to a case where a large group is formed by one or more small groups and at least one another object. In the drawing, the object 70 is represented as a rectangular shape, but the size and the shape of an object are not limited. In the drawings, a small group and a large group is represented by a frame, but an area or a frame of a small group and a large group is not required to be displayed on the screen. Alternatively, an area in proximity to multiple objects may be adopted as an area of a small group, or an area in proximity to multiple small groups may be adopted as an area of a large group. In the drawings, in order to clarify which portion is touched by each finger, a touch position is indicated by a circle, but the touch position is not required to be displayed on a screen.

FIGS. 14A and 14B illustrate examples of cases where the operation target is changed in accordance with the touch operation. For example, as shown in the left drawing of FIG. 14A, when points in an area of any one of the small groups 71b constituting the large group 71a are touched with two fingers of both hands (the index finger of the right hand and the index finger of the left hand in this case), and pinch operation for changing the distance between the two fingers (pinch out operation in this case) is performed, then, as shown in the right drawing of FIG. 14A, the touched small group 71b is adopted as the operation target, and the small group 71b is enlarged or reduced (enlarged in this case) in accordance with the change of the distance between the two fingers (processing in S404 of FIG. 13).

On the other hand, as shown in the left drawing of FIG. 14B, when points in an area of any one of the small groups 71b constituting the large group 71a are touched with two fingers of a single hand (the thumb of the right hand and the index finger of the right hand in this case), and pinch operation for changing the distance between the two fingers (pinch out operation in this case) is performed, then, as shown in the right drawing of FIG. 14B, the large group 71a (three small groups 71b in this case) is adopted as the operation target, and the entire large group 71a is enlarged or reduced (enlarged in this case) in accordance with the change of the distance between the two fingers (processing in S407 of FIG. 13).

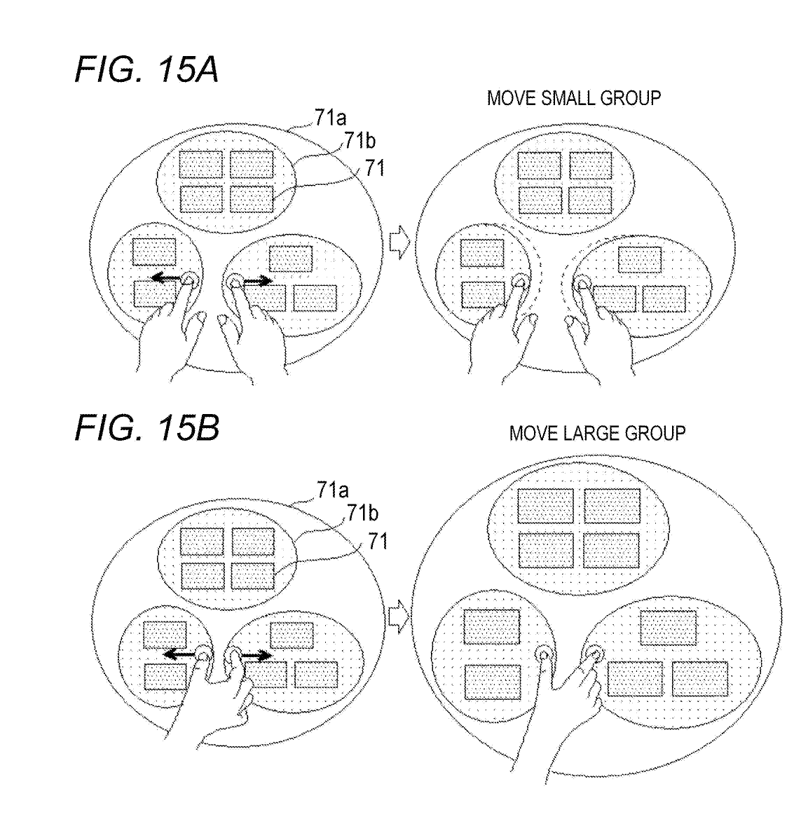

FIGS. 15A and 15B illustrate examples of cases where both of the operation target and the operation content are changed in accordance with the touch operation. For example, as shown in the left drawing of FIG. 15A, when points in areas of two small groups 71b constituting the large group 71a are touched with two fingers of both hands, and pinch operation for changing the distance between the two fingers (pinch out operation in this case) is performed, then, as shown in the right drawing of FIG. 15A, the touched two small groups 71b are adopted as the operation targets, and the two small groups 71b are moved in accordance with the change of the distance between the two fingers (processing in S406 of FIG. 13).

On the other hand, as shown in the left drawing of FIG. 15B, when points in areas of two small groups 71b constituting the large group 71a are touched with two fingers of a single hand, and pinch operation for changing the distance between the two fingers (pinch out operation in this case) is performed, then, as shown in the right drawing of FIG. 15B, the large group 71a (three small groups 71b in this case) is adopted as the operation target, and the entire large group 71a is enlarged or reduced (enlarged in this case) in accordance with the change of the distance between the two fingers (processing in S407 of FIG. 13).

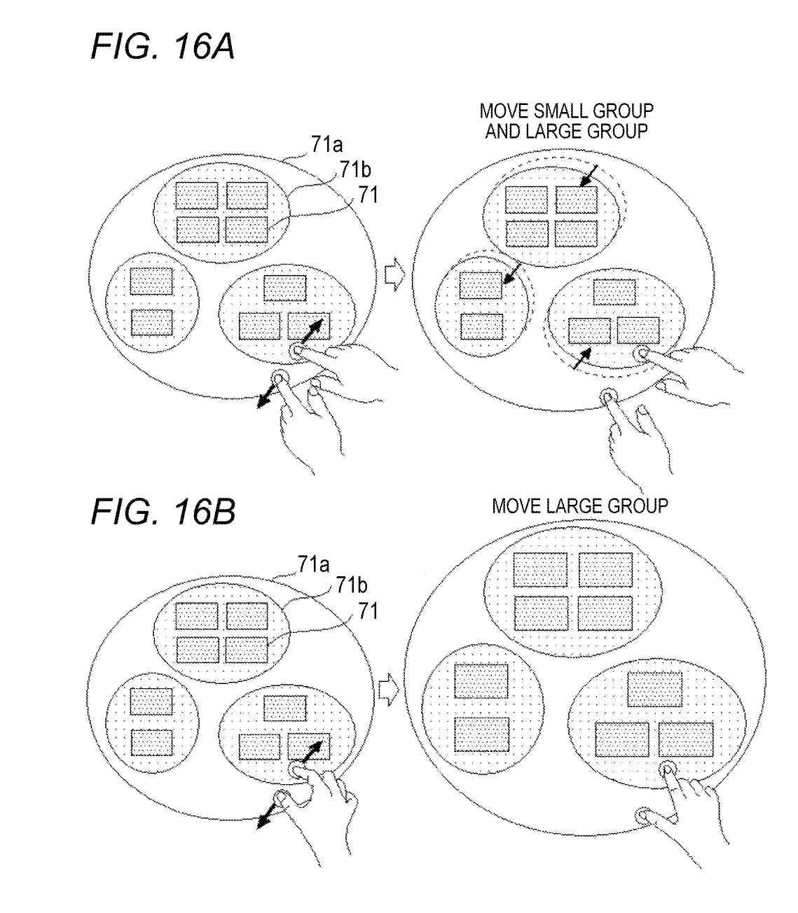

FIGS. 16A and 16B illustrate another example of a case where both of the operation target and the operation content are changed in accordance with the touch operation. For example, as shown in the left drawing of FIG. 16A, when an outside point and an inside point of an area of a small group 71b constituting a large group 71a are respectively touched with two fingers of both hands, and pinch operation for changing the distance between the two fingers (pinch out operation in this case) is performed, then, as shown in the right drawing of FIG. 16A, the touched small group 71b and the large group 71a (the small groups 71b other than the touched small group 71b) are adopted as the operation targets, and the touched small group 71b is moved in the direction of one of the fingers, and the large group 71a is moved in direction of the other of the fingers in accordance with the change of the distance between the two fingers (processing in S405 of FIG. 13).

On the other hand, as shown in the left drawing of FIG. 16B, when an outside point and an inside point of an area of a small group 71b constituting a large group 71a are respectively touched with two fingers of a single hand, and pinch operation for changing the distance between the two fingers (pinch out operation in this case) is performed, then, as shown in the right drawing of FIG. 16B, the large group 71a (three small groups 71b in this case) is adopted as the operation target, and the large group 71a is enlarged or reduced (enlarged in this case) in accordance with the change of the distance between the two fingers (processing in S407 of FIG. 13).

As described above, when the multi-touch operation is performed, the operation target (small group/large group) is switched in accordance with whether the operation is the both-hands multi-touch operation or the single-hand multi-touch operation, and further, the operation content (movement/enlarging and reducing operation and the like) is switched in accordance with the touched target. Therefore, the objects can be operated efficiently in units of groups, which can improve the user's convenience.

### Third Embodiment

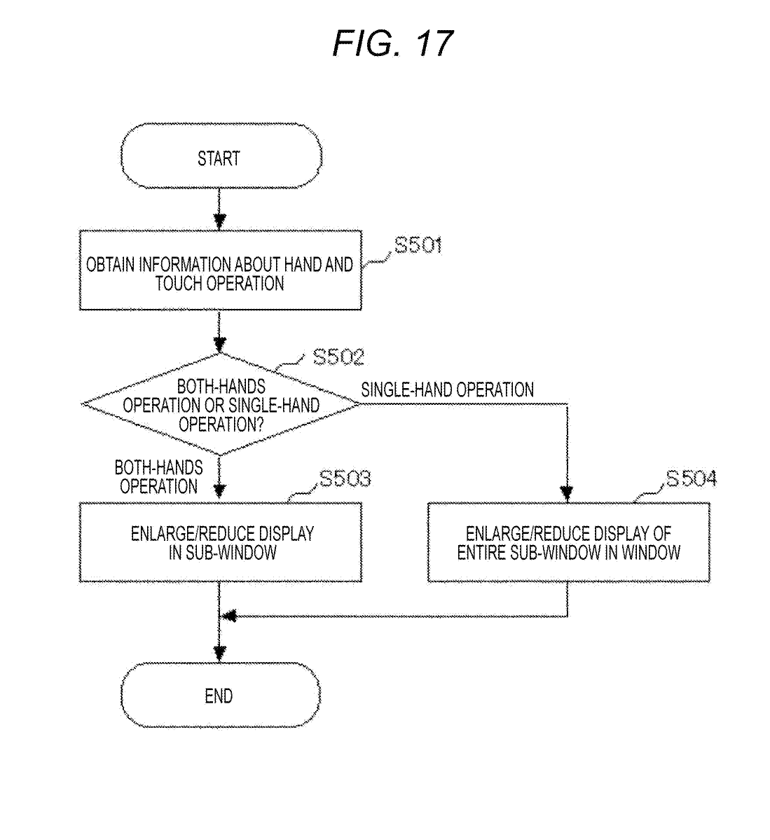

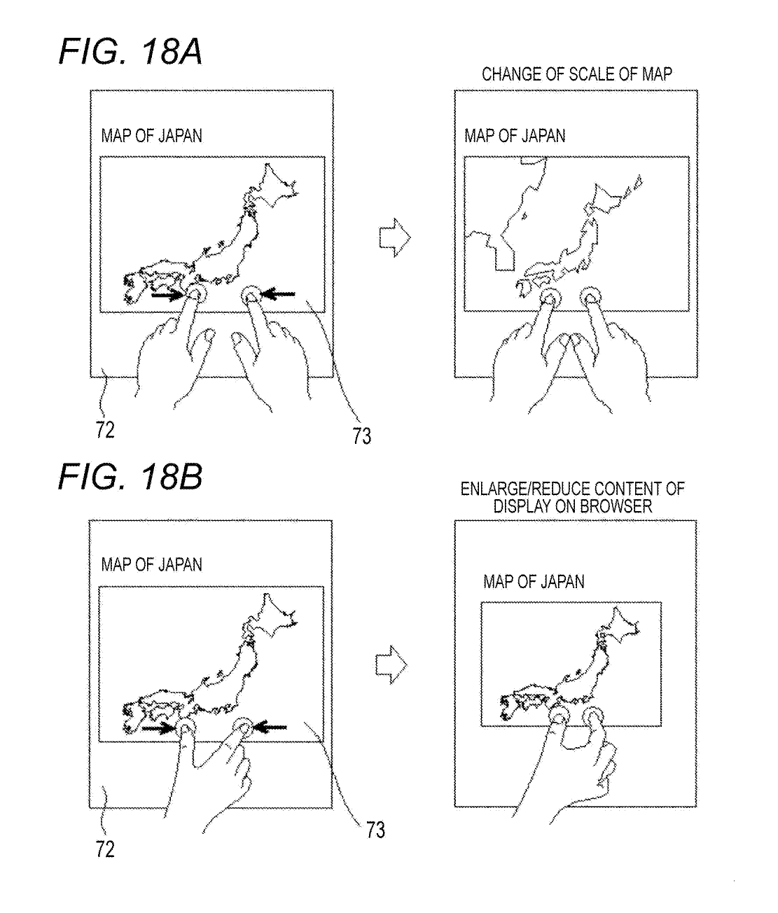

Subsequently, an object operation system, an object operation control program, and an object operation control method according to the third embodiment of the present invention will be explained with reference to FIGS. 17 to 22B. FIG. 17 is a flowchart diagram illustrating processing of an object operation system according to the present embodiment. FIGS. 18A to 22B are schematic diagrams illustrating specific examples of touch operations. The configuration of the object operation system 10 is the same as what has been described in the above embodiment, and therefore explanation thereabout is omitted.

In the first embodiment, an object or a group is adopted as an operation target, and in the second embodiment, a small group or a large group is adopted as an operation target. In the present embodiment, hereinafter explained is a window displayed on a screen of a display unit 40, a sub-window displayed inside of the window, and an operation displayed inside of the window or the sub-window are adopted as operation targets, and an operation target and an operation content are switched in accordance with the touch operation. More specifically, in the present embodiment, when a window is displayed on the screen of the display unit 40, and a sub-window is displayed inside of the window, then, an individual sub-window is adopted as an element (object), and the entire window including all the sub-windows inside of the window is treated as a group. When the window on the screen of the display unit 40 is displayed, and an object is displayed inside of the window, then, an individual object is adopted as an element, and the entire window including all the objects inside of the window is treated as a group.

The operation control method of the object in this case will be explained. The CPU 21 extracts an operation control program stored in the ROM 22 or the storage unit 30 to the RAM 23 and executes the operation control program, thus executing processing in each step as shown in the flowchart diagram of FIG. 17. In the following flow, a window is displayed on the display unit 40, and a sub-window is displayed inside of the window, and a user uses two fingers to operate a window or a sub-window on the touch panel.

First, the operation determination unit 20a obtains information about the touch operation from the operation unit 50, and obtains information about a hand with which a touch operation is performed from the detection unit 60 (S501). Then, the operation determination unit 20a compares information about a hand with which a touch operation is performed with a pattern stored in the storage unit 30 in advance, thus determining whether the touch operation is the both-hands multi-touch operation or the single-hand multi-touch operation (S502).

When the touch operation is determined to be the both-hands multi-touch operation, the processing unit 20b executes operation for enlarging and reducing the display size inside of the sub-window (for example, each object displayed inside of the sub-window (S503). On the other hand when the touch operation is determined to be the single-hand multi-touch operation, the processing unit 20b executes operation for enlarging and reducing the display size inside of the window (for example, the entire sub-window displayed inside of the window) (S404). More specifically, the operation target (sub-window/window) is switched according to whether the touch operation is the both-hands multi-touch operation or the single-hand multi-touch operation. In FIG. 17, the operation target is switched according to the touch operation, but like the first and second embodiments, both of the operation target and the operation content are switched in accordance with the touch operation.

Hereinafter, this will be explained in details with reference to FIGS. 18A to 22B. It should be noted that FIGS. 18A to 22B are examples of operation control of objects, and the operation target and the operation content can be changed as necessary. In FIGS. 18A to 22B, in order to clarify which portion is touched by each finger, a touch position is indicated by a circle, but the touch position is not required to be displayed on a screen. In FIGS. 18A to 22B, the object 70 is represented as a rectangular shape, but the size and the shape of an object are not particularly limited.

FIGS. 18A and 18B illustrate examples of cases where an operation target is changed in accordance with a touch operation. In the drawings, a sub-window 73 displaying a map is displayed inside of a window 72 of a browser, and the sub-window 73 is touched with two fingers.

As shown in the left drawing of FIG. 18A, when points in the sub-window 73 are respectively touched with two fingers of both hands (the index finger of the right hand and the index finger of the left hand in this case), and pinch operation for changing the distance between the two fingers (pinch in operation for reducing the distance in this case) is performed, then, as shown in the right drawing of FIG. 18A, the object displayed inside of the sub-window 73 (a map in this case) is adopted as an operation target, the scape of the map is changed (the map is reduced in this case) in accordance with the change of the distance between the two fingers.

On the other hand, as shown in the left drawing of FIG. 18B, when points in the sub-window 73 are respectively touched with two fingers of a single hand (the numb and the index finger of the right hand in this case), and pinch operation for changing the distance between the two fingers (pinch in operation in this case) is performed, then, as shown in the right drawing of FIG. 18B, the entire sub-window 73 in the window 72 (more specifically, a group including objects displayed inside the sub-window 73 and a frame of the sub-window 73) is adopted as an operation target, and the entire sub-window 73 in the window 72 is enlarged or reduced (reduced in this case) in accordance with the change of the distance between the two fingers.

As described above, the operation target (sub-window/window) is switched according to whether the operation is the both-hands multi-touch operation or the single-hand multi-touch operation, so that the user's convenience can be improved. For example, when a page embedded with a map is displayed with a browser, and the map is enlarged and the map is displayed on the entire browser, it is impossible to touch a location other than the map using a normal browser, and therefore, the display size of the browser cannot be changed, but according to the above control, the display size of the browser can be changed by changing the finger used for operation.

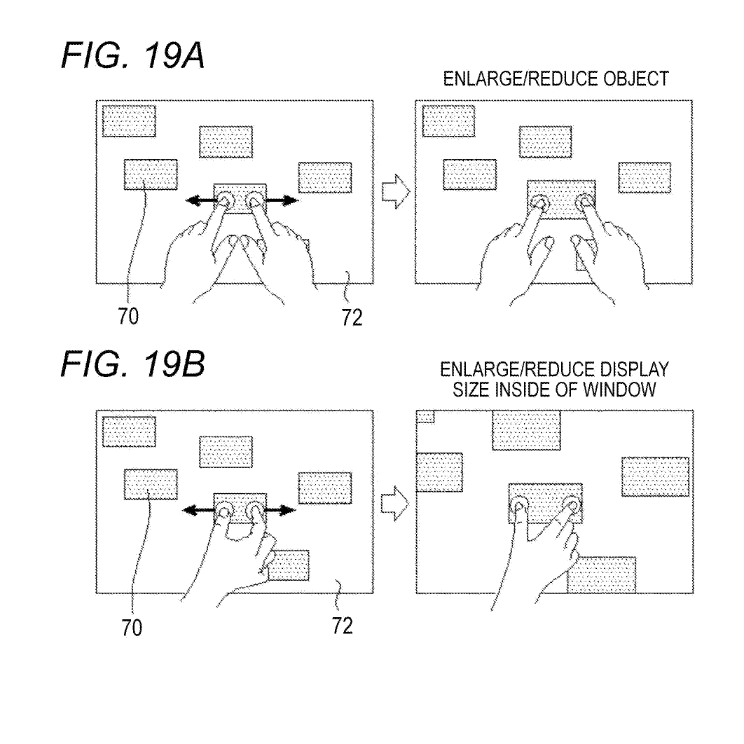

FIGS. 19A and 19B illustrate examples of cases where both of an operation target and an operation content are changed according to a touch operation. FIGS. 19A and 19B indicate multiple objects 70 are displayed inside of the window 72, and the object 70 is touched with two fingers.

As shown in the left drawing of FIG. 19A, when any one of objects 70 in the window 72 is touched with two fingers of both hands, and pinch operation for changing the distance between the two fingers (pinch out operation in this case) is performed, then, as shown in the right drawing of FIG. 19A, the element (touched object 70) is adopted as an operation target, and the touched object 70 is enlarged or reduced (enlarged in this case) in accordance with the change of the distance between the two fingers.

On the other hand, as shown in the left drawing of FIG. 19B, when anyone of objects 70 in the window 72 is touched with two fingers of a single hand, and pinch operation for changing the distance between the two fingers (pinch out operation in this case) is performed, then, as shown in the right drawing of FIG. 19B, the display size inside of the window 72 (more specifically, all the objects 70 displayed inside of the window 72) is adopted as an operation target, and the display size inside of the window 72 is enlarged or reduced (enlarged in this case) in accordance with the change of the distance between the two fingers.

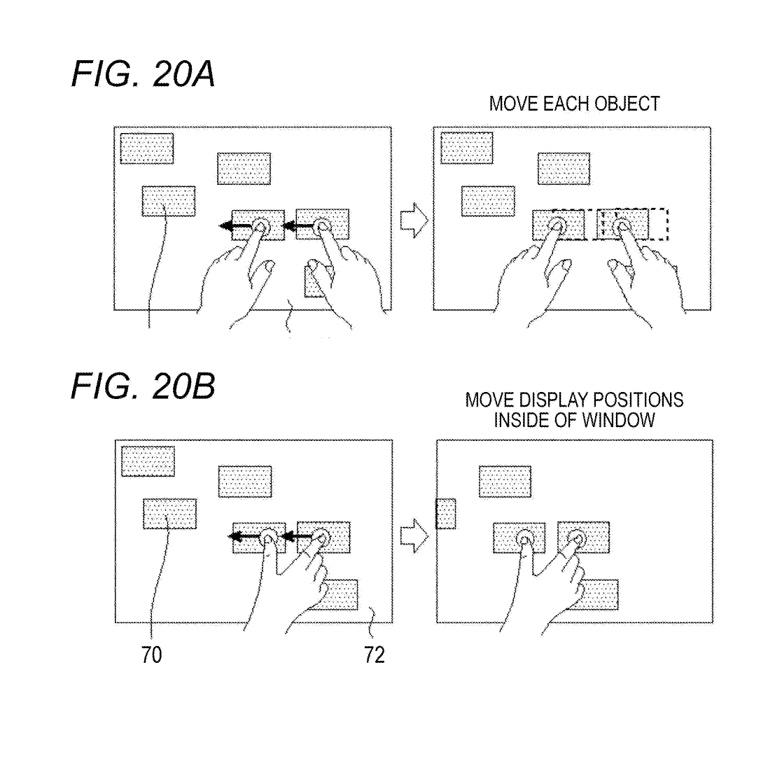

FIGS. 20A and 20B illustrate another example of cases where an operation target is changed according to a touch operation. For example, as shown in the left drawing of FIG. 20A, when two objects 70 in a window 72 are respectively touched with two fingers of both hands, and so-called drag operation for moving the two fingers in the same direction (operation for moving the two fingers to the left in this case) is performed, then, as shown in the right drawing of FIG. 20A, the elements (the two touched objects 70) are adopted as operation targets, and the two touched objects 70 are moved in accordance with the movement direction and movement distance of the two fingers.

On the other hand, as shown in the left drawing of FIG. 20B, when two objects 70 in a window 72 are respectively touched with two fingers of a single hand, and so-called drag operation for moving the two fingers in the same direction (operation for moving the two fingers to the left in this case) is performed, then, as shown in the right drawing of FIG. 20B, all the objects 70 displayed inside of the window 72 are adopted as operation targets, and the display positions of all the objects 70 displayed inside of the window 72 are moved in accordance with the change of the distance between the two fingers.

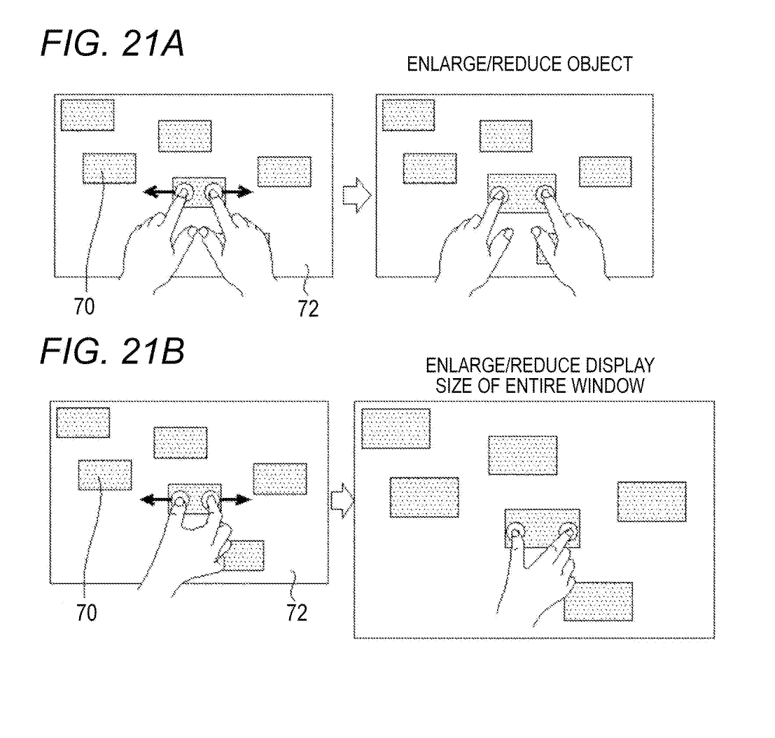

FIGS. 21A and 21B illustrate another example of cases where an operation target is changed according to a touch operation. For example, as shown in the left drawing of FIG. 21A, any one of objects 70 in the window 72 is touched with two fingers of both hands, and pinch operation for changing the distance between the two fingers (pinch out operation in this case) is performed, then, as shown in the right drawing of FIG. 21A, the elements (the touched objects 70) are adopted as operation targets, and the touched objects 70 are enlarged or reduced (enlarged in this case) in accordance with the change of the distance between the two fingers.

On the other hand, as shown in the left drawing of FIG. 21B, when any one of objects 70 in the window 72 is respectively touched with two fingers of a single hand, and pinch operation for changing the distance between the two fingers (pinch out operation in this case) is performed, then, as shown in the right drawing of FIG. 21B, the entire window 72 (more specifically, a group including objects 70 displayed inside of the window 72 and the frame of the window 72) is adopted as an operation target, and the display size of the entire window 72 is enlarged or reduced (enlarged in this case) in accordance with the change of the distance between the two fingers.

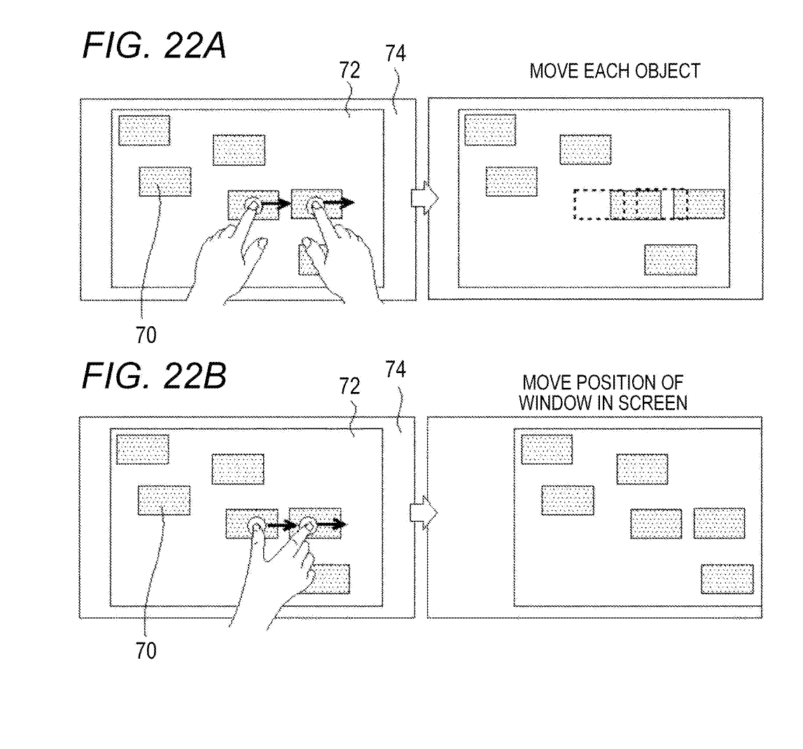

FIGS. 22A and 22B illustrate another example of cases where an operation target is changed according to a touch operation. For example, as shown in the left drawing of FIG. 22A, when two objects 70 in a window 72 displayed on the screen 74 are respectively touched with two fingers of both hands, and drag operation for moving the two fingers in the same direction (operation for moving the two fingers to the right in this case) is performed, then, as shown in the right drawing of FIG. 22A, the elements (the two touched objects 70) are adopted as operation targets, and the two touched objects 70 in the window 72 are moved in accordance with the movement direction and movement distance of the two fingers.

On the other hand, as shown in the left drawing of FIG. 22B, when two objects 70 in a window 72 displayed on the screen 74 are respectively touched with two fingers of a single hand, and drag operation for moving the two fingers in the same direction (operation for moving the two fingers to the right in this case) is performed, then, as shown in the right drawing of FIG. 22B, the entire window 72 (more specifically, a group including objects 70 displayed inside of the window 72 and the frame of the window 72) is adopted as an operation target, and the display position of the window 72 in the screen 74 is moved in accordance with the change of the distance between the two fingers.

As described above, when the multi-touch is performed, the operation target (an object, a window or a sub-window including an object, a window including a sub-window, and the like) is switched in accordance with whether the operation is the both-hands multi-touch operation the single-hand multi-touch operation, and further, the operation content (movement, enlarging and reducing operation, and the like) is switched in accordance with the touched target. Therefore, the windows and sub-windows can be operated efficiently, which can improve the user's convenience.

It should be noted that the present invention is not limited to the above embodiment, and the configuration and the control of the present invention can be changed as necessary as long as not deviating from the gist of the present invention.

For example, in the above embodiments, in the case of the both-hands multi-touch operation, a relatively small range such as an element (an object, a sub-window including an object, and the like) is adopted as an operation target, and in the case of the single-hand multi-touch operation, a relatively large range such as a group (a group including multiple objects, an entire window, and an entire sub-window) is adopted as an operation target. The operation target may be opposite, e.g., in the case of the both-hands multi-touch operation, a large range such as a group is adopted as an operation target, and in the case of the single-hand multi-touch operation, a small range such as an element is adopted as n operation target.

In the above embodiments, examples of operation contents include moving and enlarging and reducing operations, but any operation that can be performed on an element or a group may be applied.

The above embodiments have been explained using the shared screen in which multiple users can operate objects at a time. However, the object operation system according to the present invention may be an apparatus having a touch panel, and for example, the present invention can be applied to a personal computer having a touch panel and a portable terminal such as a tablet terminal and a smart phone in the same manner.

The present invention can be applied to a system capable of operating objects such as characters, figures, and images, and more particularly, the present invention can be used for a system that can be operated by multiple operators in a cooperated manner, an operation control program operating on the system, a recording medium recording an operation control program, and an operation control method controlling operation of an object on the system

Although the present invention has been described and illustrated in detail, it is clearly understood that the same is by way of illustrated and example only and is not to be taken by way of limitation, the scope of the present invention being interpreted by terms of the appended claims.

What is claimed is:

1. An object operation system comprising:
a display unit which displays an object on a screen;
an operation unit which receives a touch operation on the screen; and
a control unit controls the display unit and the operation unit,
wherein when a touch operation for touching a plurality of points on the screen at a time is performed, the control unit determines whether the touch operation is a touch operation performed with both hands or a touch operation performed with a single hand, and carries out an operation on an object in accordance with a rule which is defined differently in advance in accordance with a determination result of the touch operation.

2. The object operation system according to claim 1, wherein the control unit selects, as an operation target, any one of an element including one or more objects or a group including the element and at least another object displayed in an area corresponding to a touch position on the screen in accordance with the determination result of the touch operation.

3. The object operation system according to claim 2, wherein in a case where an element is selected by touching two points on the screen, the control unit performs control as follows: when the control unit determines that the touch operation with both hands is performed, the control unit performs operation for enlarging/reducing the element in accordance with a change of a touch interval between the two points, and when the control unit determines that the touch operation with a single hand is performed, the control unit performs operation for enlarging/reducing the group in accordance with a change of a touch interval.

4. The object operation system according to claim 2, wherein the control unit changes an operation content performed on the operation target in accordance with the determination result of the touch operation.

5. The object operation system according to claim 4, wherein in a case where two elements are selected by touching two points on the screen, the control unit performs control as follows: when the control unit determines that the touch operation with both hands is performed, the control unit performs operation for moving the two elements in accordance with a change of touch positions of the two points, and when the control unit determines that the touch operation with a single hand is performed, the control unit performs operation for enlarging/reducing the group in accordance with a change of a touch interval between the two points.

6. The object operation system according to claim 4, wherein in a case where the element and the group are selected by touching two points on the screen, the control unit performs control as follows: when the control unit determines that the touch operation with both hands is performed, the control unit performs operation for moving the element in accordance with a change of a touch position of one of them, and moving the group other than the element in accordance with a change of a touch position of the other of them, and when the control unit determines that the touch operation with a single hand is performed, the control unit performs operation for enlarging/reducing the group in accordance with a change of a touch interval between the two points.

7. The object operation system according to claim 1, wherein when a window is displayed on the screen, and a sub-window is displayed in the window and an object is displayed in the sub-window, then the control unit selects, as an operation target, any one of the sub-window or the window including the sub-window displayed in an area corresponding to a touch position on the screen in accordance with the determination result of the touch operation.

8. The object operation system according to claim 7, wherein in a case where the sub-window is selected by touching two points on the screen, the control unit performs control as follows: when the control unit determines that the touch operation with both hands is performed, the control unit performs operation for enlarging/reducing a display size inside of the sub-window in accordance with a change of a touch interval between the two points, and when the control unit determines that the touch operation with a single hand is performed, the control unit performs operation for enlarging/reducing a display size of the entire sub-window in accordance with a change of a touch interval between the two points.

9. The object operation system according to claim 1, wherein when a window is displayed on the screen and an object is displayed in the window, the control unit selects, as an operation target, any one of the object or the window displaying the object displayed in an area corresponding to a touch position on the screen in accordance with the determination result of the touch operation.

10. The object operation system according to claim 9, wherein in a case where an object is selected by touching two points on the screen, the control unit performs control as follows: when the control unit determines that the touch operation with both hands is performed, the control unit performs operation for enlarging/reducing the object in accordance with a change of a touch interval between the two points, and when the control unit determines that the touch operation with a single hand is performed, the control unit performs operation for enlarging/reducing a display size inside of the window or a display size of the entire window in accordance with a change of a touch interval between the two points.

11. The object operation system according to claim 9, wherein in a case where two objects are selected by touching two points on the screen, the control unit performs control as follows: when the control unit determines that the touch operation with both hands is performed, the control unit performs operation for moving the two objects in accordance with a change of touch positions of the two points, and when the control unit determines that the touch operation with a single hand is performed, the control unit performs operation for moving display positions of all the objects in the window or a display position of the window in the screen in accordance with a change of touch positions of the two points.

12. The object operation system according to claim 1 further comprising a detection unit which captures an image of a hand with which a touch operation is performed,
wherein when the touch operation is performed, the control unit determines whether the touch operation is a touch operation performed with both hands or a touch operation performed with a single hand, on the basis of the image of the hand of which image has been captured by the detection unit.

13. A non-transitory recording medium storing a computer readable object operation control program operating on an apparatus for controlling a touch panel, including a display unit which displays an object on a screen and an operation unit which receives a touch operation on the screen,
wherein the object operation control program causes the apparatus to execute:
first processing for, when a touch operation for touching a plurality of points on the screen at a time is performed, determining whether the touch operation is a touch operation performed with both hands or a touch operation performed with a single hand; and
second processing for carrying out an operation on an object in accordance with a rule which is defined differently in advance in accordance with a determination result of the touch operation.

14. The non-transitory recording medium storing a computer readable object operation control program according to claim 13, wherein in the second processing, any one of an element including one or more objects or a group including the element and at least another object displayed in an area corresponding to a touch position on the screen is selected as an operation target in accordance with the determination result of the touch operation.

15. The non-transitory recording medium storing a computer readable object operation control program according to claim 13, wherein in the second processing, an operation content performed on the operation target is changed in accordance with the determination result of the touch operation.

16. The non-transitory recording medium storing a computer readable object operation control program according to claim 13, wherein in the second processing, when a window is displayed on the screen, and a sub-window is displayed in the window and an object is displayed in the sub-window, then any one of the sub-window or the window including the sub-window displayed in an area corresponding to a touch position on the screen is selected as an operation target in accordance with the determination result of the touch operation.

17. The non-transitory recording medium storing a computer readable object operation control program according to claim 13, wherein in the second processing, when a window is displayed on the screen and an object is displayed in the window, any one of the object or the window displaying the object displayed in an area corresponding to a touch position on the screen is selected as an operation target in accordance with the determination result of the touch operation.

18. The non-transitory recording medium storing a computer readable object operation control program according to claim 13, wherein the touch panel further includes a detection unit which captures an image of a hand with which a touch operation is performed, and
in the first processing, when the touch operation is performed, a determination is made as to whether the touch operation is a touch operation performed with both hands or a touch operation performed with a single hand, on the basis of the image of the hand of which image has been captured by the detection unit.

19. An object operation control method for a system including a display unit which displays an object on a screen, an operation unit which receives a touch operation on the screen, and a control unit which controls the display unit and the operation unit,
wherein the control unit executes:
first processing for, when a touch operation for touching a plurality of points on the screen at a time is performed, determining whether the touch operation is a touch operation performed with both hands or a touch operation performed with a single hand; and
second processing for carrying out an operation on an object in accordance with a rule which is defined differently in advance in accordance with a determination result of the touch operation.

20. The object operation control method according to claim 19, wherein in the second processing, any one of an element including one or more objects or a group including the element and at least another object displayed in an area corresponding to a touch position on the screen is selected as an operation target in accordance with the determination result of the touch operation.

21. The object operation control method according to claim 19, wherein in the second processing, an operation content performed on the operation target is changed in accordance with the determination result of the touch operation.

22. The object operation control method according to claim 19, wherein in the second processing, when a window is displayed on the screen, and a sub-window is displayed in the window and an object is displayed in the sub-window, then any one of the sub-window or the window including the sub-window displayed in an area corresponding to a touch position on the screen is selected as an operation target in accordance with the determination result of the touch operation.

23. The object operation control method according to claim 19, wherein in the second processing, when a window is displayed on the screen and an object is displayed in the window, any one of the object or the window displaying the object displayed in an area corresponding to a touch position on the screen is selected as an operation target in accordance with the determination result of the touch operation.

24. The object operation control method according to claim 19, wherein the system further includes a detection unit which captures an image of a hand with which a touch operation is performed, and
in the first processing, when the touch operation is performed, a determination is made as to whether the touch operation is a touch operation performed with both hands or a touch operation performed with a single hand, on the basis of the image of the hand of which image has been captured by the detection unit.
